(19) United States
(12) Patent Application Publication
(10) Pub. No.: US 2023/0284071 A1
(43) Pub. Date: Sep. 7, 2023

(54) ENHANCING CONNECTION RELIABILITY USING MOTION METRICS

(71) Applicant: QUALCOMM Incorporated, San Diego, CA (US)

(72) Inventors: Nan ZHANG, Beijing (CN); Yongjun XU, Beijing (CN)

(21) Appl. No.: 18/007,445

(22) PCT Filed: Sep. 29, 2020
(86) PCT No.: PCT/CN2020/118743

§ 371 Date: Jan. 30, 2023

(51) Int. Cl. H04W 28/02; H04W 28/08

(52) U.S. Cl. CPC H04W 28/0226; H04W 28/0958

(57) ABSTRACT

Certain aspects of the present disclosure provide apparatus, methods, processing systems, and computer readable mediums for enhancing reliability of voice over new radio (VONR) in dual connectivity (DC) by duplicating quality of service (QoS) flow using motion metrics measured at the user equipment (UE). At a high level, the UE may detect a motion metric, such as rotation or displacement, and determine whether the detected motion metric exceeds a threshold. When the motion metric exceeds the threshold, the UE requests the network to duplicate the QoS flow in response to the determination.

### BACKGROUND

### Field of the Disclosure

Aspects of the present disclosure relate to wireless communications, and more particularly, to techniques for enhancing network connection reliability, such as connections of voice over new radio (VONR).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved voice over new radio (VONR) reliability and latency in NR-NR dual connectivity (DC).

Certain aspects of the subject matter described in this disclosure can be implemented in a method for wireless communication by a user equipment (UE). The method generally includes detecting a motion metric for the UE; determining that the motion metric exceeds a threshold; and requesting a network entity to duplicate a quality of service (QoS) flow in response to the determination.

Certain aspects of the subject matter described in this disclosure can be implemented in a method for wireless communication by a network entity. The method generally includes receiving a request from a user equipment (UE) to initiate a duplication of a quality of service (QoS) flow in response to a determination that a motion metric measured by the UE exceeds a threshold; and providing the duplication of QoS flow in response to the request.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is a call flow diagram illustrating an example voice over NR (VONR) session in NR-NR dual connectivity with a single quality of service (QoS) flow.

FIG. 5 illustrates an example implementation of a system-on-a-chip (SOC), in accordance with certain aspects of the present disclosure.

FIG. 6 illustrates example measurements of motion metrics (including displacement and rotation), in accordance with certain aspects of the present disclosure.

FIG. 7 is a flow diagram illustrating example operations for wireless communication by a UE, in accordance with aspects of the present disclosure.

FIG. 8 is a flow diagram illustrating example operations for wireless communication by a network entity, in accordance with aspects of the present disclosure.

FIG. 9 illustrates a flow diagram of updating QoS flow based on motion metric measured, in accordance with aspects of the present disclosure.

FIGS. 10 and 11 illustrate communication devices that include components configured to perform operations for the techniques disclosed herein, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for enhancing reliability of voice over new radio (VONR) in dual connectivity (DC) by duplicating quality of service (QoS) flow using motion metrics measured at the user equipment (UE). At a high level, the UE may detect a motion metric, such as rotation or displacement, and determine whether the detected motion metric exceeds a threshold. When the motion metric exceeds the threshold, the UE requests the network to duplicate the QoS flow in response to the determination.

In new radio (NR) FR2, the radio connection may seem unstable (e.g., when compared to FR1), even with beam enhancements. Using beam recovery, dual connectivity and other reliability enhancement solutions, NR data service reliability can be acceptable in many daily use cases. However, the VONR call beam failure tolerance is low, rendering the connection fragile. During the beam failure, the VONR call would be dropped, as explained below. Very often, the beam failure occurs when the UE is in motion (including linear displacement or translation, and rotation), and especially when the UE is in rotation. The call dropping or VONR failure cause by UE movement is often an important issue to end users.

Duplicating the QoS flow provides connection reliability and mitigates such failure. For example, with a single quality-of-service (QoS) used for a VONR in dual connectivity, a voice call may be dropped if a radio link failure (RLF) occurs on the single QoS flow. To improve reliability and latency of VONR in DC, voice packets for a voice call may be sent using more than one QoS flow using time-division duplexing (TDD). In this case, even if RLF occurs for one of the QoS flow, voice packets can still be transmitted on the other QoS flow. Thus, some voice packets may be dropped, however, the VONR voice call is not dropped.

On the other hand, duplicating the QoS flow may not be needed when a single QoS flow provides a robust and reliable connection. In such case, duplicating the QoS flow may result in unnecessary power consumption. The techniques disclosed herein allows for requesting a single QoS flow (and thus terminating duplication when not needed) if the motion metrics indicates a reliable connection.

The following description provides examples of VONR in DC with TDD in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein.

In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

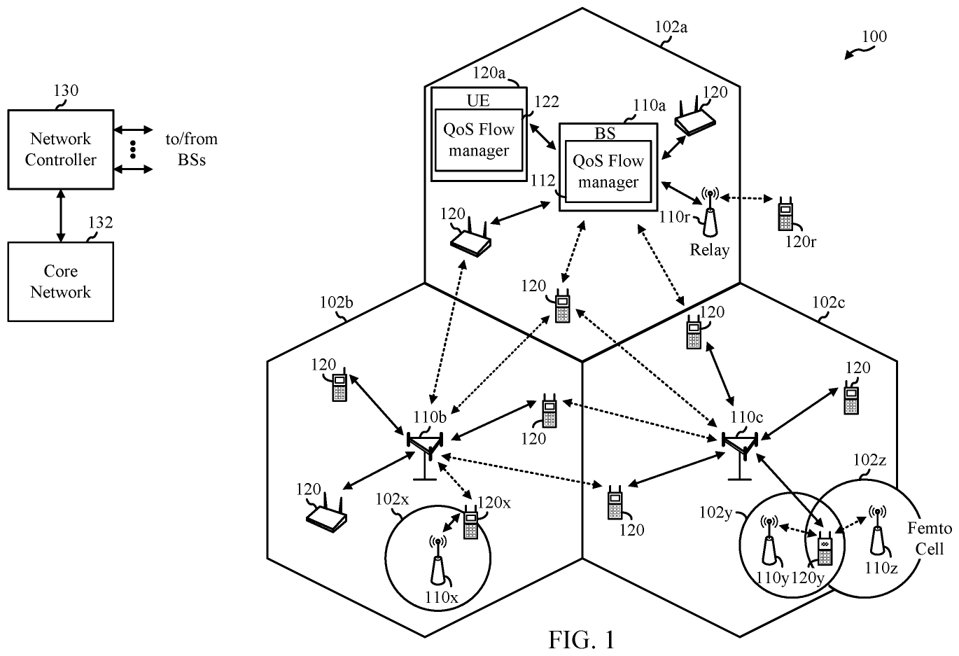

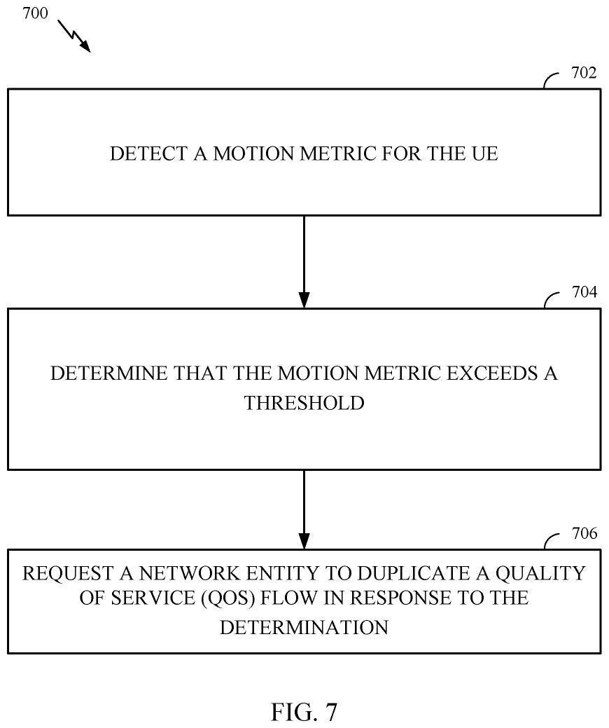

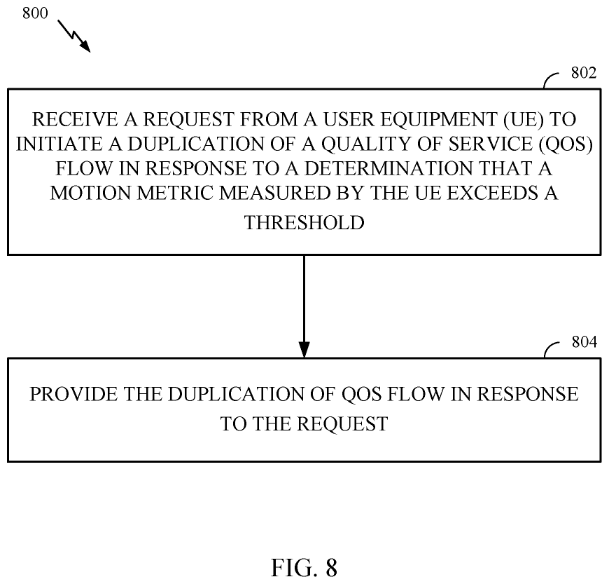

FIG. 1 illustrates an example wireless communication network 100 in which aspects of the present disclosure may be performed. For example, a BS 110 may provide duplicated QoS flow to a UE 120 upon receiving a request from the UE 120, when the UE 120 detects or measures a motion metric exceeding a threshold. The UE 120 may be configured to perform operations 700 of FIG. 7, while BS 110 is configured to perform operations 800 of FIG. 8.

The wireless communication network 100 may be an NR system (e.g., a 5G NR network). As shown in FIG. 1, the wireless communication network 100 may be in communication with a core network 132. The core network 132 may in communication with one or more base station (BSs) 110a-110z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

According to certain aspects, the BSs 110 and UEs 120 may be configured for VONR in DC with TDD. As shown in FIG. 1, the BS 110a includes a QoS flow manager 112 that schedules a UE for transmission of packets on a first QoS flow associated with a first network and a second QoS flow associated with a second network, and receives the packets from the UE via at least one of the first QoS flow or the second QoS flow, in accordance with aspects of the present disclosure. The UE 120a includes a QoS flow manager 122 that receives a configuration for transmission of packets on a first QoS flow associated with a first network and a second QoS flow associated with a second network, and sends the packets on the first QoS flow and the second QoS flow, in accordance with aspects of the present disclosure.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

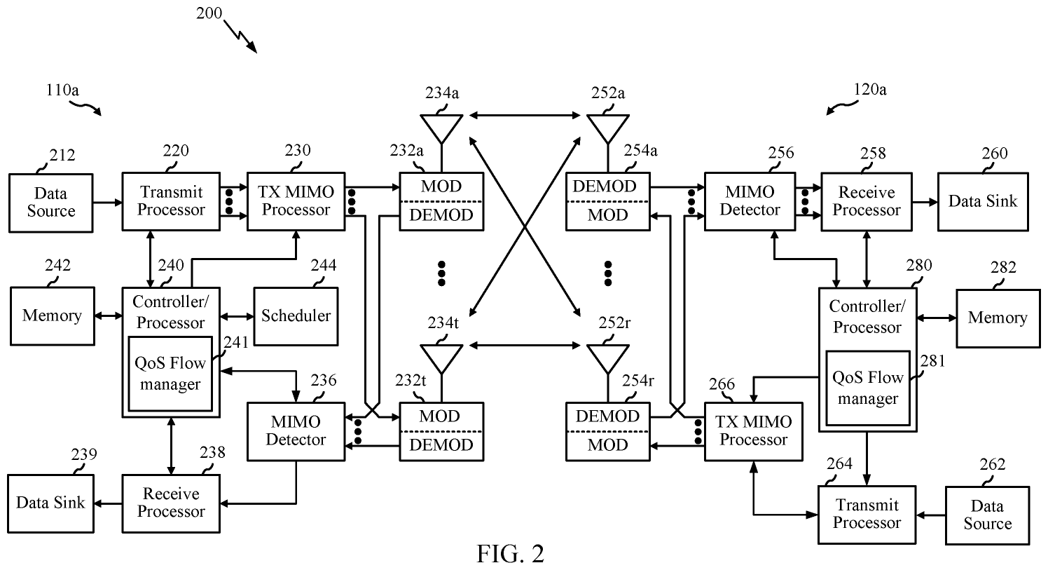

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has an QoS manager 241 that schedules a UE for transmission of packets on a first QoS flow associated with a first network and a second QoS flow associated with a second network, and receives the packets from the UE via at least one of the first QoS flow or the second QoS flow, according to aspects described herein. As shown in FIG. 2, the controller/processor 280 of the UE 120a has an QoS manager 281 that receives a configuration for transmission of packets on a first QoS flow associated with a first network and a second QoS flow associated with a second network, and sends the packets on the first QoS flow and the second QoS flow, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

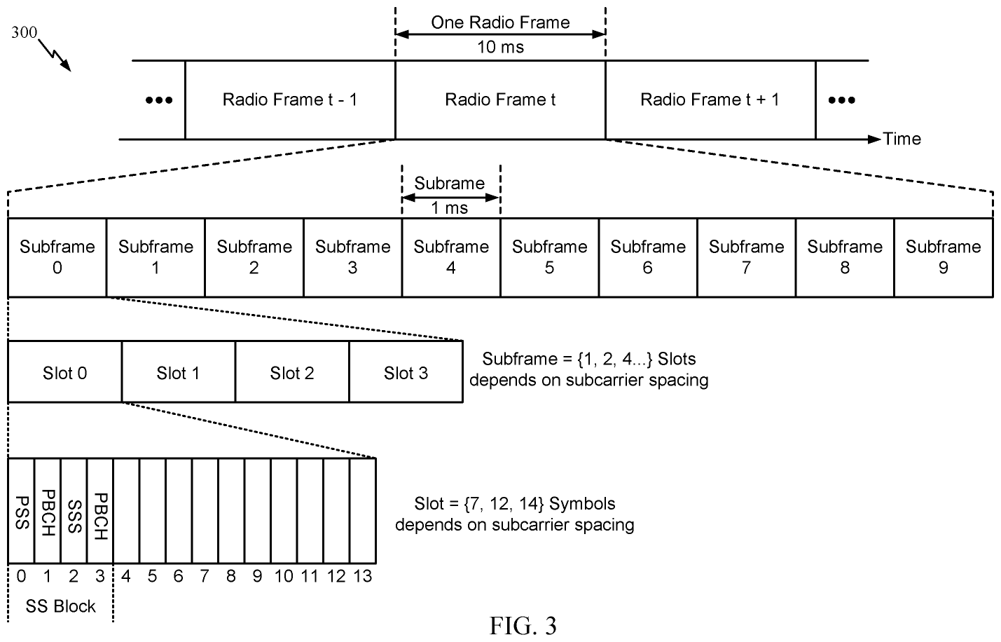

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

As mentioned above, aspects of the present disclosure relate to VONR. Voice over NR (VONR) is an Internet Protocol (IP) multimedia system (IMS) calling service that uses the 5G NR network as a source of IP voice processing. In VONR, the UE camps on the 5G NR network and voice/video communication and data services are carried on the 5G NR network. When the UE moves to an area where the NR signal coverage is poor, a coverage based handover may be initiated to implement interworking with a 4G network. Then the UE can handover to the LTE network and Voice-over-LTE (VoLTE) network service can be provided.

Currently, a single quality of service (QoS) flow is often used for VONR (and may be duplicated upon requests, as disclosed herein). Where as in LTE, QoS is enforced at the evolved packet system (EPS) bearer level, in 5G, QoS is enforced at the QoS flow level. For example, LTE uses EPS bearers assigned an EPS bearer ID, and 5G uses 5G QoS flows each identified by a QoS flow ID (QFI). 5G supports guaranteed bit rate (GBR) and non-GBR flows, along with a new delay-critical GBR. 5G also introduces reflective QoS.

The QoS flow may be the lowest level of granularity of QoS differentiation in a protocol data unit (PDU) session within the 5G system. The QoS flow is where policy and charging are enforced. One or more service data flows (SDFs) may be transported in the same QoS flow, if they share the same policy and charging rules. All traffic within the same QoS flow receives the same treatment. Within the 5G system (5GS), a QoS flow is controlled by the 5G session management function (SMF) and may be preconfigured, or established via the PDU session establishment procedure or the PDU session modification procedure. A QoS flow is characterized by a QoS profile provided by the SMF, one or more QoS rules (and optionally QoS flow level QoS parameters associated with the QoS rules), and one or more uplink and downlink packet delivery ratio (PDR). A QoS flow associated with the default QoS rule is established for a PDU session and remains established throughout the lifetime of the PDU session.

5G QoS identifier (5QI) values provide QoS characteristics (e.g., resource type, priority level, delay budge, packet error rate, default maximum data burse volume, default averaging window, example services). An illustrative example of 5QI values mapped to QoS characteristics is provided in Table 5.7.4-1 of 3GPP TS 23.501.

The UE may be configured for VONR service in a multi-RAT dual connectivity (MR-DC) scenario. In MR-DC, the Master RAN node may function as the controlling entity, utilizing a Secondary RAN for additional data capacity. Example MR-DC configurations include E-UTRA-NR DC (EN-DC), NR-DC, NG-RAN-E-UTRA DC (NGEN-DC), NR-E-UTRA DC (NE-DC), and NR-NR DC.

NR-NR DC uses the SGC, where both master and secondary RAN nodes are 5G gNBs. For UEs configured for NR-NR DC, the single QoS flow may be scheduled with either a single dedicated radio bearer (DRB) or split DRBs of a master cell group (MCG) and a secondary cell group (SCG).

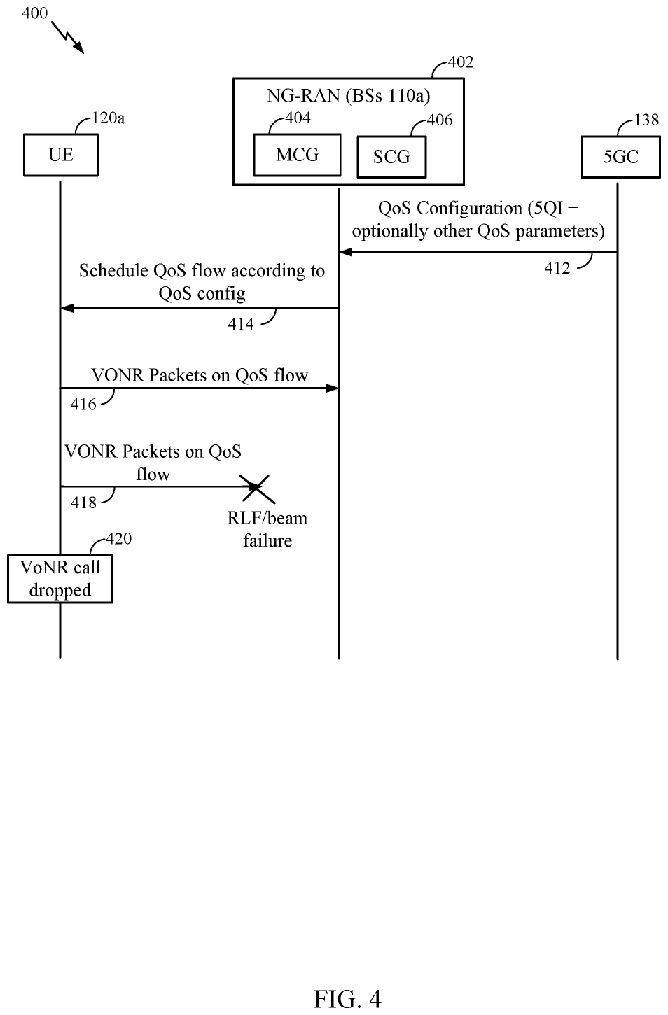

FIG. 4 illustrates example signaling for VONR using a single QoS flow. As shown in FIG. 4, at 412, the 5G core network (5GC), such as the core network 132, assigns a single VONR QoS flow with a 5QI (e.g., and optionally additional QoS parameters) to the 5G new-generation radio access network 402 (NG-RAN), such as to a BS 110a. At 414, the NG-RAN 402 schedules the UE 120a with the QoS flow following the 5QI (and other QoS parameters). For example, the NG-RAN 402 may schedule VONR communications for the UE 120a. At 416, the UE 120 may transmit voice packets for the VONR session on the single QoS flow. However, if a radio link failure (RLF) or beam failure happens (at 418), the voice call will be dropped (at 420).

In NR-NR dual connectivity, duplicate packet data convergence protocol (PDCP) protocol data units (PDUs) in the MCG and the SCG may enhance application reliability and VONR reliability, however, duplicate PDCP PDUs may use twice as many radio resources and may impact the latency of VONR as the UE may wait for both duplicate PDUs packets to arrive.

Accordingly, what is needed are techniques and apparatus for improving VONR service in NR-NR dual connectivity, such as with improved reliability and reduced latency.

### Example Connection Reliability Enhancement by Motion Adaptive Quality of Service (QoS) Flow Duplication

Aspects of the present disclosure provide voice over new radio (VONR) enhancements by duplicating quality-of-service (QoS) flows based on motion metrics detected for a user equipment (UE). For example, movement information can be monitored by built-in sensors of the UE. When UE is in excessive motion or rotation the UE may request RAN to duplicate VONR QOS flow. In some cases, the duplicated QOS Flow may be scheduled to MCG (PCell) and SCG (PSCell) concurrently. If one of the two connections fails, the other duplicated VONR QOS flow may be used to ensure continuous connection.

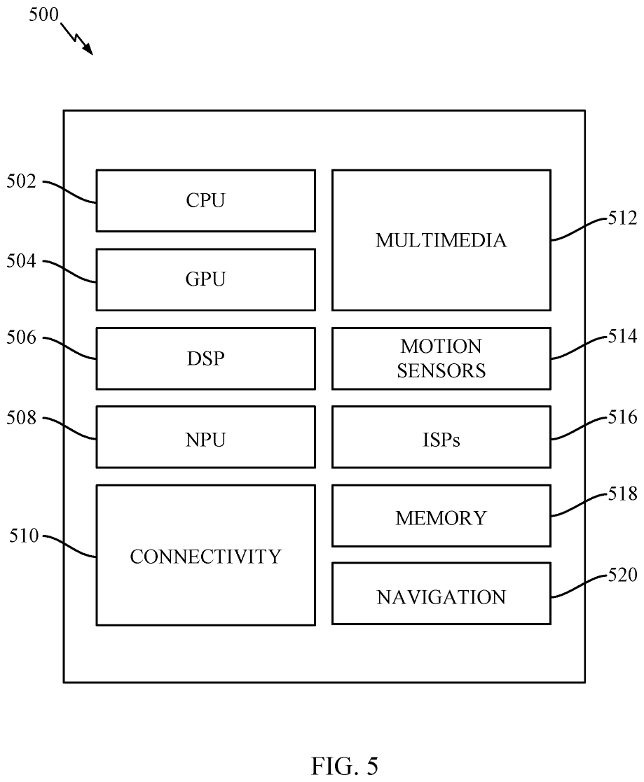

According to certain aspects, a motion metric, such as a measurement of an acceleration of a rate of one of rotation or translation/displacement, may be detected for the UE. The motion metric may be used to evaluate potential connection disruption caused by the corresponding motion, by comparing the motion metric against a threshold. When the motion metric exceeds the threshold, the UE may request a network entity (such as a base station) to duplicate the QoS flow, to mitigate any potential disconnection due to the motion of the UE. For example, the UE may measure or detect the motion metric using the one or more components shown in FIG. 5.

FIG. 5 illustrates an example implementation of a system-on-a-chip (SOC) 500, which may include a central processing unit (CPU) 502, in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing, unit (NPU) 508, in a memory block associated with a CPU 502, in a memory block associated with a graphics processing unit (GPU), in a memory block associated with a digital signal processor (DSP) 144, in a memory block 518, or may be distributed across multiple blocks. Instructions executed at the CPU 502 may be loaded from a program memory associated with the CPU 502 or may be loaded from a memory block 518.

The SOC 500 may also include additional processing blocks tailored to specific functions, such as a GPU 504, a DSP 506, a connectivity block 510, which may include fifth generation (5G) connectivity, fourth generation long term evolution (4G LTE) connectivity, Wi-Fi connectivity, USB connectivity, Bluetooth connectivity, and the like, and a multimedia processor 512 that may, for example, detect and recognize swipe gestures. In one implementation, the NPU is implemented in the CPU, DSP, and/or GPU.

The SOC 500 may be based on an ARM instruction set. In an aspect of the present disclosure, the instructions loaded into the CPU 502 may comprise code to receive a swipe gesture input sequence on a virtual keyboard of the touchscreen. In addition, the instructions loaded into the CPU 502 may comprise code to sense at least one parameter indicative of motion. The instructions loaded into the CPU 502 may further comprise code to determine a character sequence based on the swipe gesture input sequence and the at least one parameter indicative of the motion.

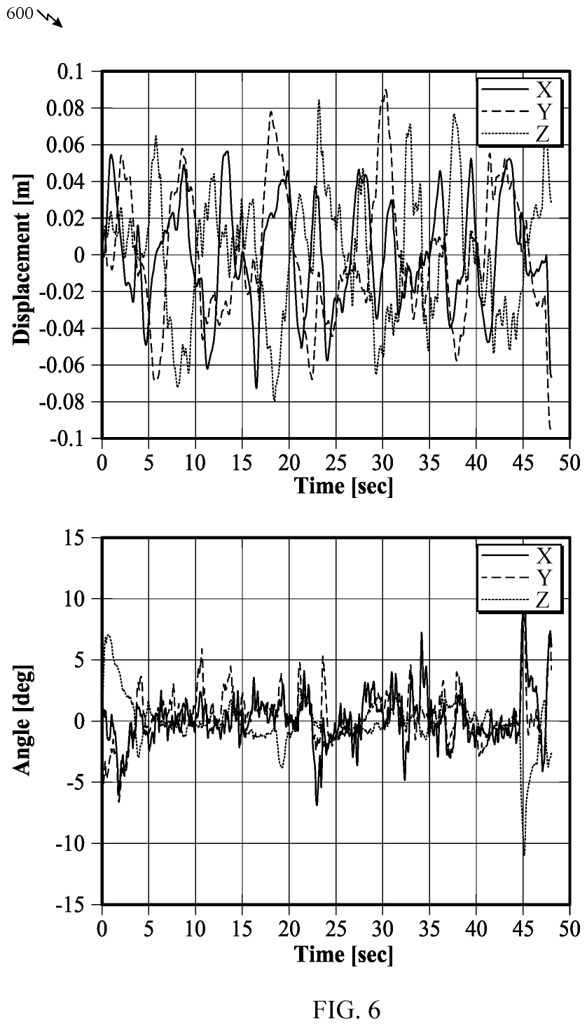

The SOC 500 may also include or be coupled with one or more motion sensors 514 (may include onboard processors), image signal processors (ISPs) 516, and/or navigation module 550, which may include a global positioning system (GPS). In certain aspects, the motion sensors 514 may operate as or receive input from one or more of accelerometers, gyroscopes, or inertia measurement units (IMUs). The motion sensors 514 may provide the motion metric detection or measurement to the UE for determining whether a QoS flow is to be duplicated. For example, FIG. 6 illustrates example measurements of motion metrics (including displacement and rotation).

In FIG. 6, the top graph shows displacement measurements in the vertical axis, the displacements measured in x, y, and z axes of the UE during a period of time (as indicated in the horizontal axis of the graph). The bottom graph shows rotation measurements in the vertical axis. The rotation in degrees measured in x, y, and z axes of the UE are plot against the same period of time (indicated in the horizontal axis) as the displacement measurements. As shown, in some instances the magnitude of movements measured by the motion sensors far exceeds an average or a median of the data measured, or a preconfigured threshold value based on tests or experiments. Therefore, the movement data measured by the onboard motion sensors of the UE may trigger the duplication of QoS flow as disclosed herein.

FIG. 7 is a flow diagram illustrating example operations 700 for wireless communication by a UE, in accordance with aspects of the present disclosure. For example, operations 700 may be performed by a UE such as the UE 120 of FIGS. 1 and 2. The UE may include one or more components as illustrated in FIG. 2 which may be configured to perform the operations described herein. For example, the antenna 252a, demodulator/modulator 254a, controller/processor 280, and/or memory 282 as illustrated in FIG. 2 may perform the operations described herein.

Operations 700 begin, at 702, by detecting a motion metric for the UE. For example, the motion metric is detected using at least one onboard sensor, such as an accelerometer, a gyroscope, or an inertia measurement unit (IMU). In some cases, the motion metric measures an acceleration or a rate of at least one of rotation or translation of the UE.

At 704, the UE determines that the motion metric exceeds a threshold. For example, the UE may determine that excessive rotation or displacement has occurred, which can disrupt the current connection. At 706, the UE requests a network entity to duplicate a quality of service (QoS) flow in response to the determination.

FIG. 8 illustrates example operations 800 for wireless communications by network entity. For example, operations 800 may be performed by the base station 110 of FIGS. 1 and 2. The operations 800 may be considered complementary to operations 700 of FIG. 7, such as, for example, to respond to the UE's request to duplicate a QoS flow. According to aspects, the network entity may include one or more components as illustrated in FIG. 2 which may be configured to perform the operations described herein. For example, the antenna 234, demodulator/modulator 232, controller/processor 240/220, and/or memory 242 as illustrated in FIG. 2 may perform the operations described herein.

Operations 800 begin, at 802, by receiving a request from a user equipment (UE) to initiate a duplication of a quality of service (QoS) flow in response to a determination that a motion metric measured by the UE exceeds a threshold. At 804, the network entity provides the duplication of QoS flow in response to the request. As such, a connection using the duplicated QoS flow between the UE and the network entity can be established.

In certain aspects, the QoS flow includes a voice over new radio (VONR) QoS flow.

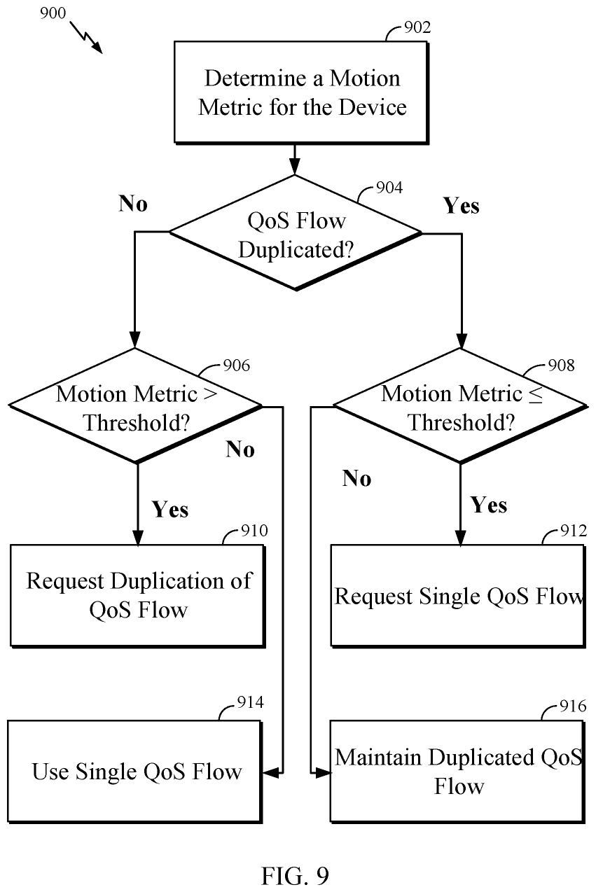

In certain aspects, the UE determines that the QoS flow has become unreliable (i.e., based on the motion metric) and uses the duplicated QoS flow in communication with the network entity, such as to avoid any potential dropping or disconnection on the original QoS flow. In certain aspects, the UE determines that the motion metric is below or equals to the threshold. As such, duplication of the QoS flow may not be necessary. The UE then requests the network entity to stop duplicating the QoS flow in response to the determination. For example, terminating the duplication may save power consumption and extend usage when the UE is on battery. Example operations are further illustrated in FIG. 9, which illustrates a flow diagram 900 of updating QoS flow based on motion metric measured.

The flow diagram 900 in FIG. 9 starts at 902 by determining a motion metric for a device (e.g., the UE 120), which has been operating in either a single or a duplicated QoS flow. At 904, the configuration regarding if the QoS flow has been duplicated is ascertained.

At 904, if the device is operating using a single QoS flow (i.e., upon determining “No” to the left), then the device determines, at 906, whether the measured motion metric is greater than a first threshold. The first threshold may be predetermined by factory testing or otherwise specified based on its location or subsequent communication with the network. If the motion metric is greater than the first threshold, at 910, the device requests a duplication of QoS flow. Otherwise, at 914, the device continues to use the single QoS flow.

At 904, if the device is operating using duplicated QoS flow (i.e., upon determining “Yes” to the right), then the device determines, at 908, whether the measured motion metric is less than or equals to a second threshold. The second threshold may be the same or different from the first threshold. For example, the second threshold may be lower than the first threshold to ensure connection robustness by not giving up the duplicated QoS flow prematurely. If the motion metric is less than or equals to the second threshold, at 912, the device requests a single QoS flow. Otherwise, at 916, the device maintains the duplicated QoS flow.

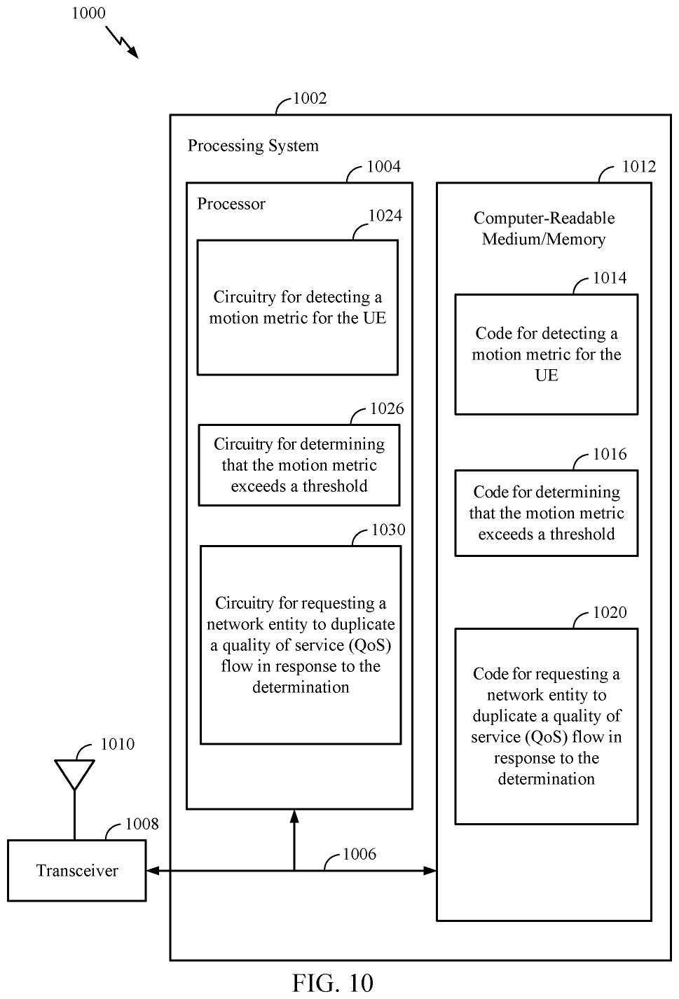

FIG. 10 illustrates a communications device 1000 that may include various components (e.g., corresponding to means-plus-function components) configured to perform operations for the techniques disclosed herein, such as the operations illustrated in FIG. 8. The communications device 1000 includes a processing system 1002 coupled to a transceiver 1008. The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 8. In certain aspects, computer-readable medium/memory 1012 stores code 1014 for detecting a motion metric for the UE; code 1016 for determining that the motion metric exceeds a threshold, and code 1020 for requesting a network entity to duplicate a quality of service (QoS) flow in response to the determination. In certain aspects, the processor 1004 has circuitry configured to implement the code stored in the computer-readable medium/memory 1012. The processor 1004 includes circuitry 1024 for detecting a motion metric for the UE; circuitry 1026 for determining that the motion metric exceeds a threshold, and circuitry 1030 for requesting a network entity to duplicate a quality of service (QoS) flow in response to the determination.

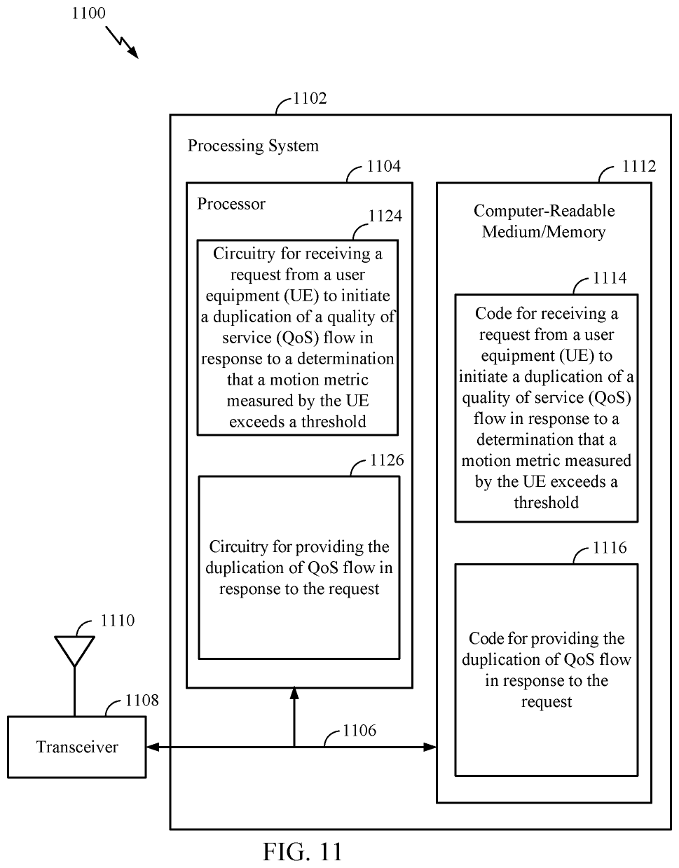

FIG. 11 illustrates a communications device 1100 that may include various components (e.g., corresponding to means-plus-function components) configured to perform operations for the techniques disclosed herein, such as the operations illustrated in FIG. 9. The communications device 1100 includes a processing system 1102 coupled to a transceiver 1108. The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 9. In certain aspects, computer-readable medium/memory 1112 stores code 1114 for receiving a request from a user equipment (UE) to initiate a duplication of a quality of service (QoS) flow in response to a determination that a motion metric measured by the UE exceeds a threshold; and code 1116 for providing the duplication of QoS flow in response to the request. In certain aspects, the processor 1104 has circuitry configured to implement the code stored in the computer-readable medium/memory 1112. The processor 1104 includes circuitry 1124 for receiving a request from a UE to initiate a duplication of a QoS flow in response to a determination that a motion metric measured by the UE exceeds a threshold; and circuitry 1126 for providing the duplication of QoS flow in response to the request.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

### Example Embodiments

Embodiment 1: A method for wireless communication by a user equipment (UE), comprising: detecting a motion metric for the UE; determining that the motion metric exceeds a threshold; and requesting a network entity to duplicate a quality of service (QoS) flow in response to the determination.

Embodiment 2. The method of Embodiments 1, wherein the motion metric is detected using at least one onboard sensor.

Embodiment 3. The method of any of Embodiments 1-2, wherein the QoS flow comprises a voice over new radio (VONR) QoS flow.

Embodiment 4. The method of any of Embodiments 1-3, further comprising establishing a connection using the duplicated QoS flow.

Embodiment 5. The method of any of Embodiments 1-4, wherein the motion metric measures an acceleration or a rate of at least one of rotation or translation.

Embodiment 6. The method of any of Embodiments 1-5, further comprising: determining that the QoS flow has become unreliable; and utilizing the duplicated QoS flow in communication with the network entity.

Embodiment 7. The method of any of Embodiments 1-6, further comprising: determining that the motion metric is below or equals to the threshold; and requesting the network entity to stop duplicating the QoS flow in response to the determination.

Embodiment 8. A method for wireless communication by a network entity, comprising: receiving a request from a user equipment (UE) to initiate a duplication of a quality of service (QoS) flow in response to a determination that a motion metric measured by the UE exceeds a threshold; and providing the duplication of QoS flow in response to the request.

Embodiment 9. The method of Embodiments 8, further comprising receiving a request from the UE to terminate the duplication of the QoS flow in response to a determination that the motion metric measured by the UE is within or equals to the threshold.

Embodiment 10. The method of any of Embodiments 8-9, wherein the motion metric is detected using at least one onboard sensor.

Embodiment 11. The method of any of Embodiments 8-10, wherein the QoS flow comprises a voice over new radio (VONR) QoS flow.

Embodiment 12. The method of any of Embodiments 8-11, further comprising connecting with the UE using the duplicated QoS flow.

Embodiment 13. The method of any of Embodiments 8-12, wherein the motion metric measures an acceleration or a rate of at least one of rotation or translation.

Embodiment 14. The method of any of Embodiments 8-13, further comprising: determining that the QoS flow has become unreliable; and utilizing the duplication of QoS flow in communication with the UE.

Embodiment 15. An apparatus for wireless communication by a user equipment (UE), comprising: means for detecting a motion metric for the UE; means for determining that the motion metric exceeds a threshold; and means for requesting a network entity to duplicate a quality of service (QoS) flow in response to the determination.

Embodiment 16. An apparatus for wireless communication by a network entity, comprising: means for receiving a request from a user equipment (UE) to initiate a duplication of a quality of service (QoS) flow in response to a determination that a motion metric measured by the UE exceeds a threshold; and means for providing the duplication of QoS flow in response to the request.

Embodiment 17. An apparatus for wireless communication by a user equipment (UE), comprising at least one processor and a memory configured to: detect a motion metric for the UE; determine that the motion metric exceeds a threshold; and request a network entity to duplicate a quality of service (QoS) flow in response to the determination.

Embodiment 18. An apparatus for wireless communication by a network entity, comprising at least one processor and a memory configured to: receive a request from a user equipment (UE) to initiate a duplication of a quality of service (QoS) flow in response to a determination that a motion metric measured by the UE exceeds a threshold; and provide the duplication of QoS flow in response to the request.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 7 and/or FIG. 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a user equipment (UE), comprising:
detecting a motion metric for the UE;
determining that the motion metric exceeds a threshold; and
requesting a network entity to duplicate a quality of service (QoS) flow in response to the determination.

2. The method of claim 1, wherein the motion metric is detected using at least one onboard sensor.

3. The method of claim 1, wherein the QoS flow comprises a voice over new radio (VOLAR) QoS flow.

4. The method of claim 1, further comprising establishing a connection using the duplicated QoS flow.

5. The method of claim 1, wherein the motion metric measures an acceleration or a rate of at least one of rotation or translation.

6. The method of claim 1, further comprising:
determining that the QoS flow has become unreliable; and
utilizing the duplicated QoS flow in communication with the network entity.

7. The method of claim 1, further comprising:
determining that the motion metric is below or equals to the threshold; and
requesting the network entity to stop duplicating the QoS flow in response to the determination.

8. A method for wireless communication by a network entity, comprising:
receiving a request from a user equipment (UE) to initiate a duplication of a quality of service (QoS) flow in response to a determination that a motion metric measured by the UE exceeds a threshold; and
providing the duplication of QoS flow in response to the request.

9. The method of claim 8, further comprising receiving a request from the UE to terminate the duplication of the QoS flow in response to a determination that the motion metric measured by the UE is within or equals to the threshold.

10. The method of claim 8, wherein the motion metric is detected using at least one onboard sensor.

11. The method of claim 8, wherein the QoS flow comprises a voice over new radio (VOLAR) QoS flow.

12. The method of claim 8, further comprising connecting with the UE using the duplicated QoS flow.

13. The method of claim 8, wherein the motion metric measures an acceleration or a rate of at least one of rotation or translation.

14. The method of claim 8, further comprising:
determining that the QoS flow has become unreliable; and
utilizing the duplication of QoS flow in communication with the UE.

15. An apparatus for wireless communication by a user equipment (UE), comprising:
means for detecting a motion metric for the UE;
means for determining that the motion metric exceeds a threshold; and
means for requesting a network entity to duplicate a quality of service (QoS) flow in response to the determination.

16. An apparatus for wireless communication by a network entity, comprising:
means for receiving a request from a user equipment (UE) to initiate a duplication of a quality of service (QoS) flow in response to a determination that a motion metric measured by the UE exceeds a threshold; and
means for providing the duplication of QoS flow in response to the request.

17. An apparatus for wireless communication by a user equipment (UE), comprising:
at least one processor and a memory configured to:
detect a motion metric for the UE;
determine that the motion metric exceeds a threshold; and
request a network entity to duplicate a quality of service (QoS) flow in response to the determination.

18. An apparatus for wireless communication by a network entity, comprising:
at least one processor and a memory configured to:
receive a request from a user equipment (UE) to initiate a duplication of a quality of service (QoS) flow in response to a determination that a motion metric measured by the UE exceeds a threshold; and
provide the duplication of QoS flow in response to the request.
